(19) United States
(12) Patent Application Publication
(10) Pub. No.: US 2008/0044701 A1
(43) Pub. Date: Feb. 21, 2008

(54) CONNECTING MEMBER, A HYDROGEN GENERATION APPARATUS AND A FUEL CELL SYSTEM

(75) Inventors: Fuminobu Tezuka, Yokohama-shi (JP); Hiroaki Hirazawa, Tokyo (JP); Hideo Kitamura, Yokohama-shi (JP); Akihiko Ono, Tokyo (JP); Yoshiyuki Isozaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/841,278

(22) Filed: Aug. 20, 2007

(30) Foreign Application Priority Data
Aug. 21, 2006 (JP) 2006-223827

(51) Int. Cl. H01M 8/18; B32B 1/00

(52) U.S. Cl. 429/20; 422/189; 428/36.5; 428/36.91

(57) ABSTRACT

A connecting member includes a metallic inner tube surrounding a flow path through which fluid flows; a polyimide resin-made outer tube covering an outer circumference of the inner tube; and a polyimide resin-made intermediate layer provided between the inner tube and the outer tube.

### CROSS REFERENCE TO RELATED APPLICATIONS AND INCORPORATION BY REFERENCE

This application is based upon and claims the benefit of priority from the prior Japanese Patent Application No. P2006-223827, filed on Aug. 21, 2006; the entire contents of which are incorporated herein by reference.

### BACKGROUND OF THE INVENTION

1. Field of the Invention

The present invention relates to a fuel cell system, a hydrogen generation apparatus for the fuel cell system, and a connecting member for the hydrogen generation apparatus.

2. Description of the Related Art

In a chemical reaction system, a reactor (a first reactor) is connected to another reactor (a second reactor) by a connecting member such as a piping. The respective reactors are set to have preferred temperature conditions so that the chemical reaction proceeds. The temperature conditions may be set to a temperature close to a room temperature depending on uses and purposes, but may be set to a high temperature of about a few hundred ° C. In particular, highly-reactive hydrogen-containing fluid at high temperature of a few hundred ° C. are distributed in a hydrogen generation apparatus, a fuel cell system, or the like. Thus, it is important to select reactors and connecting members that are highly resistive to corrosion and that can endure a high temperature environment.

In recent years, in order to use a hydrogen generation apparatus and a fuel cell system for a small power source for a mobile device, for example, reactors and connecting members have been required to have a smaller size. However, as reactors and connecting members have a smaller size, thermal conduction problems of the connecting members connected between the reactors cannot be ignored.

Generally, when reactors in which chemical reaction proceeds under different temperature conditions are connected, it is required to provide a fixed distance or more between the reactors to minimize the amount of heat transferred between the reactors as much as possible. However, a shorter distance between reactors for a smaller size apparatus may cause a connecting member to function as a thermal conduction medium, thus making it difficult to control the temperature of a reactor at lower temperature. The difficulty in the control of temperature of a reactor at lower temperature deteriorates the thermal efficiency of the reactor at higher temperature. Therefore, a thermal efficiency and a reaction efficiency of the entire system will be decreased.

A stainless-steel tube which is used for a direct contact type heat exchanger system in a fuel cell (For instance, refer to JP-A (KOKAI) No. 8-49996.) is known as a connecting member used for the hydrogen generation apparatus and the fuel cell system. As the connecting member that can be used under a high temperature environment (e.g., engine room), a fuel piping resin tube using thermoplastic elastomer (TPE) resin has been known (For instance, refer to JP-A (KOKAI) No. 2005-265102.). Furthermore, a multilayer piping that has a structure sandwiching a metallic layer between resin layers having barrier properties to hydrogen-containing fluid is known (For instance, refer to JP-A (KOKAI) No. 2005-214387.).

However, the stainless-steel tube disclosed in JP-A (KOKAI) No. 8-49996 has a high thermal conductivity. Therefore, when the apparatus is assembled so that temperature conditions of the reactor at higher temperature do not affect temperature conditions of the reactor at lower temperature, the connecting member is required to have an increased length. This causes an increased space occupied by the connecting member, causing the entire system to have a larger size.

Furthermore, in the case of the thermoplastic resin tube in JP-A (KOKAI) No. 2005-265102, TPE resin used as material has a melting point of 250° C. or less. Therefore, under an environment such as the one required by a hydrogen generation apparatus, for example, in which organic raw material are required to be reformed at high temperature of 200 to 300° C., the thermoplastic tube or the TPE resin used for the inner wall will be deteriorated by the heat. When deteriorated resin by the heat is decomposed so as to be contaminated in a flow path, a trouble in the system will be caused. Furthermore, when fluid passing in a thermoplastic resin tube has a high penetrability (e.g., mixed solution of dimethyl ether, methanol, water, and so forth) such that osmotic agents can penetrate through the thermoplastic resin tube used for the inner wall, or when the resin used for the inner wall react with the penetrated substance so that the resin is deteriorated, the performance of the system will be deteriorated so as to manifest a lower reliability.

Furthermore, in the invention described in JP-A (KOKAI) No. 2005-214387 as well as in JP-A (KOKAI) No. 2005-265102, resin of inner tube material is deteriorated and softened by heat. Furthermore, a medium passing through the inner tube expands in the inner wall. Therefore, the invention described in JP-A (KOKAI) No. 2005-214387 cannot be applied for a hydrogen generation apparatus or the like being operated under high temperature conditions such as 2500C.

### SUMMARY OF THE INVENTION

An aspect of the present invention inheres in a connecting member encompassing a connecting member encompassing a metallic inner tube surrounding a flow path for fluid; a polyimide resin-made outer tube covering the inner tube; and a polyimide resin-made intermediate layer provided between the inner tube and the outer tube.

Still another aspect of the present invention inheres in a hydrogen generation apparatus encompassing a vaporizer configured to vaporize at least one of organic raw material and water to generate organic matter-containing gas; a hydrogen generator configured to generate hydrogen-containing fluid from the organic matter-containing gas; a carbon monoxide removal unit configured to remove carbon monoxide from the hydrogen-containing fluid; and a connecting member provided between at least any of the vaporizer, the hydrogen generator, and the carbon monoxide removal unit, including a metallic inner tube surrounding a flow path for the hydrogen-containing fluid; a polyimide resin-made outer tube covering the inner tube; and a polyimide resin-made intermediate layer provided between the inner tube and the outer tube.

Still another aspect of the present invention inheres in a hydrogen generation apparatus encompassing a vaporizer configured to vaporize at least one of organic raw material or water to generate organic matter-containing gas; a hydrogen generator configured to generate hydrogen-containing fluid from the organic matter-containing gas; a carbon monoxide shift unit configured to shift carbon monoxide in the hydrogen-containing fluid to carbon dioxide and hydrogen; a methanation unit configured convert carbon monoxide in the hydrogen-containing fluid to methane and water; and a connection member provided between the carbon monoxide shift unit and the methanation unit, including a metallic inner tube surrounding a flow path for the hydrogen-containing fluid; a polyimide resin-made outer tube covering an outer circumference of the inner tube; and a polyimide resin-made intermediate layer provided between the inner tube and the outer tube.

Still another aspect of the present invention inheres in a fuel cell system encompassing a container containing organic raw material and water; a vaporizer configured to vaporize at least one of the organic raw material or the water to generate organic matter-containing gas; a reformer configured to reform the organic matter-containing gas to hydrogen-containing fluid; a carbon monoxide removal unit configured to remove carbon monoxide from the hydrogen-containing fluid; a power generation unit configured to generate electric power through a reaction of oxygen with the hydrogen-containing gas from which the carbon monoxide is removed; a combustor configured to combust an exhausted gas exhausted from the power generation unit; and a connecting member provided between at least any of the vaporizer, the reformer, the carbon monoxide removal unit, the power generation unit, and the combustor, including a metallic inner tube surrounding a flow path for the hydrogen-containing fluid; a polyimide resin-made outer tube covering the inner tube; and a polyimide resin-made intermediate layer provided between the inner tube and the outer tube.

### BRIEF DESCRIPTION OF DRAWINGS

FIG. 1 is a cross-sectional view illustrating a connecting member according to an embodiment of the present invention;

FIG. 2 is a cross-sectional view taken on line A-A in FIG. 1 and illustrates the connecting member according to the embodiment;

FIG. 3 is a perspective view illustrating an example of a couple of connecting members, which are connected to a reactor such that the reactor is sandwiched by the connecting members according to the embodiment;

FIG. 4 is a perspective view illustrating an example of three connecting members being connected to two reactors, alternately, according to the embodiment;

FIG. 5 is a perspective view illustrating three connecting members connected alternately to a plurality of layered reactors according to the first embodiment;

FIG. 6 is a cross-sectional view illustrating an example of a connecting member according to a modification of the embodiment;

FIG. 7A is a schematic diagram illustrating a connecting member used for thermal characteristic-evaluation according to the embodiment;

FIG. 7B is a schematic diagram illustrating a connecting member used for thermal characteristic-evaluation according to the embodiment;

FIG. 7C is a schematic diagram illustrating a connecting member used for thermal characteristic-evaluation according to the embodiment;

FIG. 7D is a schematic diagram illustrating a connecting member used for thermal characteristic-evaluation according to the embodiment;

FIG. 8A is a table showing an evaluation result of thermal characteristics of the connecting member according to the embodiment;

FIG. 8B is a table showing an evaluation result of thermal characteristics of the connecting member according to the embodiment;

FIG. 8C is a table showing an evaluation result of thermal characteristics of the connecting member according to the embodiment;

FIG. 8D is a table showing an evaluation result of thermal characteristics of the connecting member according to the embodiment;

FIG. 9 is a schematic diagram illustrating an overall structure of a hydrogen generation apparatus (fuel cell system) according to the embodiment of the present invention; and

FIG. 10 is a perspective view illustrating example of specific structure of the hydrogen generation device (fuel cell system) according to the embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous details are set forth such as specific signal values, etc. to provide a thorough understanding of the present invention. However, it will be obvious to those skilled in the art that the present invention may be practiced without such specific details.

### (Connecting Member)

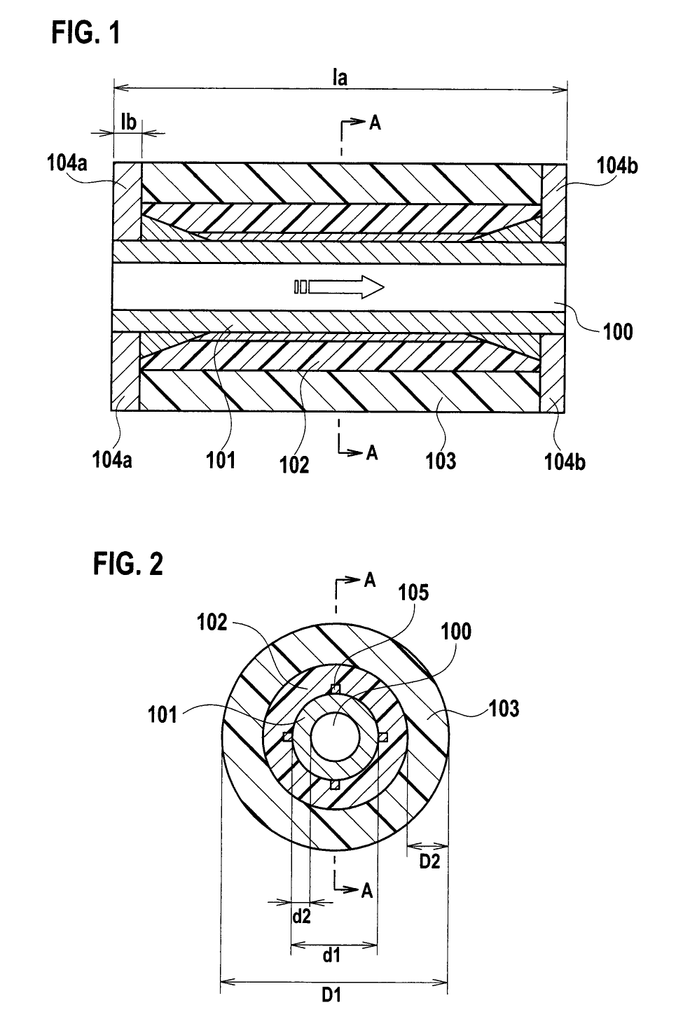

As shown in FIG. 1 and FIG. 2, a connecting member according to an embodiment of the present invention includes a metallic inner tube 101 surrounding a flow path 100 in which hydrogen-containing fluid flows; a polyimide resin-made outer tube 103 covering an outer circumference of the inner tube 101; and a polyimide resin-made intermediate layer 102 sandwiched between the inner tube 101 and the outer tube 103. Linkage sections 104a and 104b for joining reactors (not shown) at different temperatures are provided at both ends of the connecting member.

FIG. 2 shows an example of a cross-sectional view seen in the direction A-A of FIG. 1. A rib 105 is provided at the outer circumference of the inner tube 101. The rib 105 fixes the intermediate layer 102 to prevent the intermediate layer 102 from moving between the inner tube 101 and the outer tube 103.

The inner tube 101 can be made of such metal that endures a high temperature environment and that can be easily machined to form joints for example (e.g., aluminum, copper, steel, stainless steel). However, when the inner tube 101 is used for a small reaction system in which hydrogen-containing fluid or the like flows, the inner tube 101 is preferably made of stainless steel having lower thermal conductivity than those of aluminum, copper, and the like. A member having a high thermal conductivity is preferably required to have a minimized cross section. Thus, the inner tube 101 is preferably designed so as to implement a minimized thickness (thickness d2 of FIG. 2) in view of reliability, safety or the like of a system to be used.

For example, a mobile device application requires the inner tube 101 to have a structure that can withstand an impact (e.g., drop). Under the circumstances, the inner tube 101 is required to have a thick thickness with increased weight in despite of the smaller weight requirement. When the inner tube 101 is used for a stationary system, on the other hand, consideration of an impact (e.g., drop) is not required and thus the thickness may be modified appropriately. The inner tube 101 is also required to have a thickness to endure a differential pressure between fluid flowing at the inner side of the inner tube 101 and an outer environment of the outer tube 103. Thus, the thickness of the inner tube 101 is preferably optimized depending on a system to be used.

The inner tube 101 can be made of material chosen in terms of easiness of making joints between the inner tube 101 and the reactor, or the like. For example, when the reactor or the like is made of SUS316L (JIS standard), SUS316L is selected as material for the inner tube 101 to provide an identical linear expansion coefficient characteristic and thus provides an improved joint reliability.

An example of the inner tube 101 preferred for a hydrogen generation apparatus (which will be described later) includes, for example, a stainless-steel tube having an internal withstand-pressure of 5.88×10⁵ Pa (6 kgf/cm²), a length (length 1a of FIG. 1) of 10 to 100 mm, lengths of linkage sections 104a and 104b (length 1b of FIG. 1) of 1 to 5 mm, an outer diameter (diameter d1 of FIG. 2) of 1.0 to 2.5 mm, and a thickness (thickness d2 of FIG. 2) of 0.05 to 0.15 mm. For example, a special tube having a thin thickness and being made of SUS316L or SUS304L (JIS standard) can be used.

The outer tube 103 can be made of material that has a lower thermal conductivity than that of metal, or the like, and that has a high workability (i.e., fluorinated resin, epoxy resin, polyimide resin). Here, it is understood that fluorinated resin has an upper limit of the working temperature of about 180° C. and epoxy resin has an upper limit of the working temperature of about 250° C., respectively. When the outer tube 103 is used for a small reaction system for generating hydrogen-containing fluid for example, the outer tube 103 may be preferably made of polyimide resin that can be used under a high temperature environment of 250° C. or more.

Polyimide has a thermal conductivity λ of about 0.29 W/(m·K) at 300 K for example. Thus, polyimide has an effect of suppressing thermal conduction compared with silica glass having the thermal conductivity λ of 1.38 W/(m·K) at 300 K, alumina having the thermal conductivity λ of 36.0 W/(m·K) at 300 K, or stainless steel (SUS304 (JIS standard)) having the thermal conductivity λ of 16.0. W/(m·K) at 300 K. The outer tube 103 preferred for a hydrogen generation apparatus (which will be described later) may be, for example, a polyimide resin-made tube having an outer diameter (diameter D1 of FIG. 2) of 2.00 to 5.00 mm and a thickness (thickness D2 of FIG. 2) of 0.5 to 2.0 mm.

The intermediate layer 102 preferably includes polyimide resin that has a lower thermal conductivity than that of the inner tube 101 and that has a higher thermal conductivity than that of the outer tube 103 (e.g., polyimide resin foam and polyimide adhesive agent). An the interface between the inner tube 101 having a high thermal conductivity and the outer tube 103 having a low thermal conductivity has thermal stress due to a difference in the linear expansion coefficient due to temperature gradient. When the intermediate layer 102 is composed of polyimide resin having an intermediate thermal conductivity, thermal stress due to a difference in the linear expansion coefficient can be reduced and a highly-reliable connecting member can be provided. Furthermore, the intermediate layer 102 suppresses thermal conduction in the radial direction of the connecting member shown in FIG. 2 and thus the connecting member can have a high thermal efficiency.

In order to provide the intermediate layer 102 with a lower thermal conductivity than that of the inner tube 101 and a higher thermal conductivity than that of the outer tube 103, the intermediate layer 102 may include therein a plurality of foams. For example, the intermediate layer 102 may be made of polyimide resin having a plurality of closed cells. The closed cells are filled with gas having a lower thermal conductivity than that of drying air. This can suppress thermal conduction in the tube radial direction when compared with a case where a closed cell is filled with air, thus providing a higher thermal efficiency. It is noted that the closed cell-type resin foam also may be substituted by an interconnected cell-type resin foam.

Foams may be preferably filled with inert gas such as argon, carbon dioxide, nitrogen, or krypton. The intermediate layer 102 can be filled with inert gas by mixing liquid-like polyimide resin foam with polyimide adhesive agent to heat the mixture to have an increased temperature so that carbon dioxide gas, nitrogen or the like is generated and retained in polyimide resin foam, or by actively filling inert gas (argon) in polyimide adhesive agent to subsequently disperse the inert gas to cure the polyimide adhesive agent.

The foam of the intermediate layer 102 filled with inert gas can prevent, even when the inner tube 101 is broken in the worst case, inert gas from reacting with fluid flowing in the flow path 100 at the inner side of the inner tube 101, thus providing safety. Furthermore, even when inert gas filled in the intermediate layer 102 flows in the flow path 100 in the inner tube 101, the gas does not have a major impact on the chemical reaction in the respective reactors and thus the entire system can have a high reliability.

The linkage sections 104a and 104b may be made of stainless steel as in the inner tube 101. The linkage sections 104a and 104b may have a length 1b (see FIG. 1) by which the linkage sections 104a and 104b can be joined depending on the type of a reactor and a welding method for example. The linkage sections 104a and 104b may be shaped depending on a reactor joined to the linkage sections 104a and 104b or a welding method.

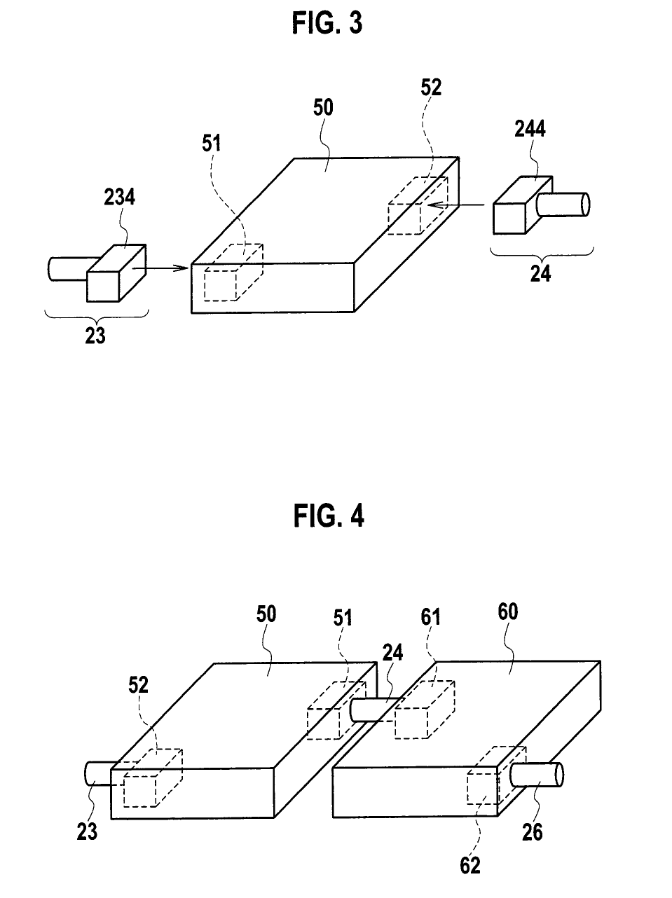

To facilitate a laser welding architecture, for example, connecting members 23 and 24 and a reactor 50 are prepared firstly, as shown in FIG. 3. The connecting members 23 and 24 respectively have linkage sections 234 and 244 having an outer shape of a rectangular column. The reactor 50 has engagement sections 51 and 52 in which the linkage sections 234 and 244 are engaged. The linkage section 234 is engaged into the engagement section 51 and the linkage section 244 is engaged into the engagement section 52 to subject the reactor 50 and outer side faces of the linkage sections 234 and 244 to a laser welding for joint. The welding can be performed more easily when the linkage sections 234 and 244 have a circular column-like or rectangular column shape because a light source or a work should be moved during the welding. The use of laser welding can avoid sintering even when the reactor 50 already includes catalyst.

The linkage sections 234 and 244 may have a tapered shape (not shown) to provide an easier welding in a case where the connecting members 23 and 24 are joined by the welding of tungsten inert gas (TIG). When soldering or brazing is used, the linkage sections 234 and 244 as well as the engagement sections 51 and 52 are preferably shaped so as to be easily surrounded by solder or brazing material.

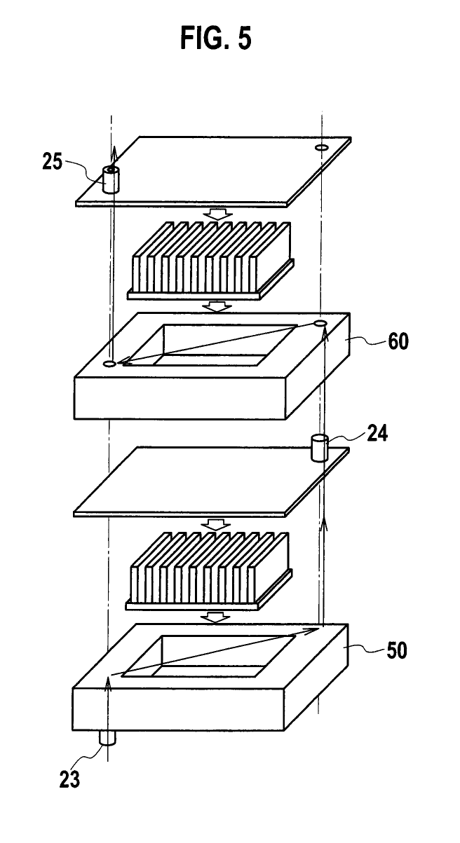

As shown in FIG. 4, when another reactor (second reactor) 60 operating at different temperature from the reactor (first reactor) 50 is connected to each other, an end of the connecting member 24 is engaged with an engagement section 61 provided at the inlet side of the reactor 60 and a linkage section (not shown) of a connecting member 26 is engaged with an engagement section 61 provided at the inlet side of the reactor 60. As shown in FIG. 5, the connecting members 23 to 25 can be used in a system having a plurality of layered reactors (reactors 50 and 60).

When the connecting members shown in FIG. 1 and FIG. 2 are manufactured, polyimide resin foam is fixed at an outer circumference of a special thin tube for example by polyimide adhesive agent. Then, the special thin tube is sandwiched by polyimide resin and is placed in a furnace at 300° C. to cure the polyimide adhesive agent. The intermediate layer 102 shown in FIG. 1 also may include a polyimide film.

In order to suppress the thermal conduction in the axial direction of a connecting member, any of the following approaches can be used based on the heat transfer engineering:

(1) To increase a distance between small reactors at different temperature conditions;

(2) To reduce the thermal conductivity of a connecting member; and

(3) To reduce the size of the cross section of a connecting member.

In order to realize a smaller system, the methodology (1) cannot be used. Thus, a connecting member considering the methodologies (2) and (3) are required to be examined. According to the connecting members shown in FIG. 1 and FIG. 2, the intermediate layer 102 and the outer tube 103 are made of polyimide resin and thus can have a lower thermal conductivity than that of a grass member, ceramics, metal or the like. Furthermore, polyimide resin is strong against heat when compared with fluorinated resin and polyimide resin and thus can endure a high temperature of 250° C. or more.

However, polyimide resin poorly endures when the composition includes water vapor or water. Thus, it is not preferable to implement a connecting member by using polyimide resin only. According to the connecting member shown in FIG. 1, the inner tube 101 having a contact with fluid is made of stainless steel. Thus, the inner tube 101 shows, even when highly-reactive gas such as hydrogen flows there through, a higher durability than that of a connecting member made of polyimide resin only. By minimizing the thickness (width d2 of FIG. 2) of the inner tube 101 as much as possible, a metallic part can have a reduced cross section and thus thermal conduction can be suppressed. For example, by halving the thickness of a stainless-steel ⅛ inch tube (outer diameter of 3.16 mm and thickness of 0.89 mm), the cross section of the tube can be reduced from about 6.34 mm² to 2.55 mm². Thus, a smaller size can be obtained and applications to a mobile electronic device in particular can be achieved.

Furthermore, the connecting member shown in FIG. 1 can be assembled such that an intermediate layer 102 can be made of polyimide resin foam is employed so that thermal conduction from the center of the connecting member to the outer side in the radial direction can be suppressed, thereby providing an improved thermal efficiency. Furthermore, when an intermediate layer 102 having a plurality of foams, serving as cushioning material to an exterior impact, can be employed so as to accommodate a difference in the thermal expansion rate between the inner tube 101 and the outer tube 103. Although another structure in which the intermediate layer 102 does not have foams and the outer tube 103 has foams is also possible, the outer tube 103 in this case is preferably made of resin foam having a closed cell. The reason is that closed cell can seal gas filed in the foam and thus thermal conduction is suppressed.

As described above, the connecting member according to the embodiment of the present invention can achieve different reaction temperature conditions between reactors, while reducing a distance between the reactors, the difference in the temperature between the reactors facilitates an easy temperature control. Furthermore, the reduced thermal conduction can suppress the thermal dissipation in the respective reactors to provide the respective reactors with an improved thermal efficiency.

### (Modification)

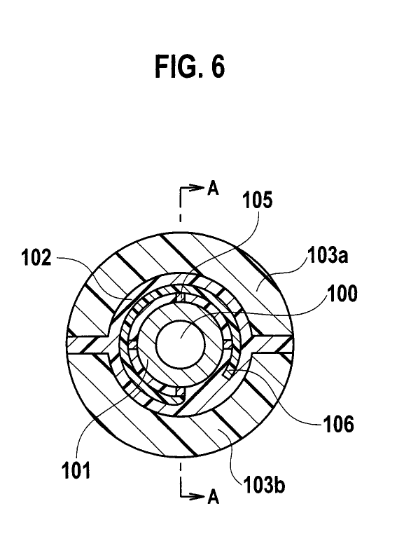

As shown in FIG. 6, a Connecting Member according to a modification of the embodiment is different from the connecting member as shown in FIG. 2 in that the connecting member includes outer tubes 103a and 103b and a polyimide film 106 provided with the intermediate layer 102. The outer tubes 103a and 103b may be prepared by dividing VESPEL® to two parts in the axial direction to engage the parts to each other face to face so that the parts are opposed to each other.

In order to manufacture the connecting member shown in FIG. 6, the outer tube 103 of polyimide resin is firstly placed at the outer side of the inner tube 101. In such a case, the outer tube 103 may be made of polyimide resin selected from among various polyimide resins that can endure an operation temperature of a reactor at higher temperature. Then the outer tube 103 of polyimide resin is divided to two parts in the axial direction to engage the parts to each other. Thereafter, commercially-available polyimide adhesive agent is allowed to flow in the intermediate layer 102 between the inner tube 101 and the outer tube 103 to increase the temperature of the entirety to a curing temperature to cure the polyimide adhesive agent.

The intermediate layer 102 also may be obtained by mixing polyimide adhesive agent with polyimide film 106 or polyimide resin foam (not shown). Specifically, commercially-available polyimide resin foam or foamed polyimide film also may be wound around the outer side of the inner tube 101 and the resultant inner tube 101 is externally engaged with the outer tubes 103a and 103b to flow liquid-like polyimide adhesive agent between the inner tube 101 and the outer tubes 103a and 103b to cure the agent at predetermined temperature. Alternatively, polyimide resin foam or polyimide film also may be placed at the intermediate layer 102 to use polyimide adhesive agent to join the outer tube 103 only.

### (Thermal Evaluation of the Connecting Member)

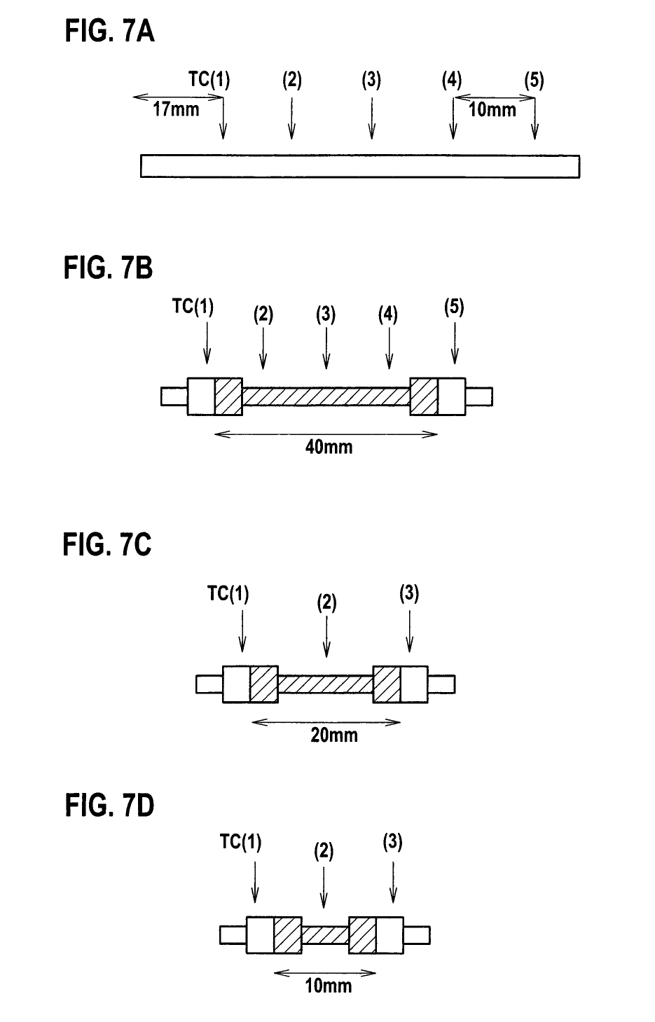

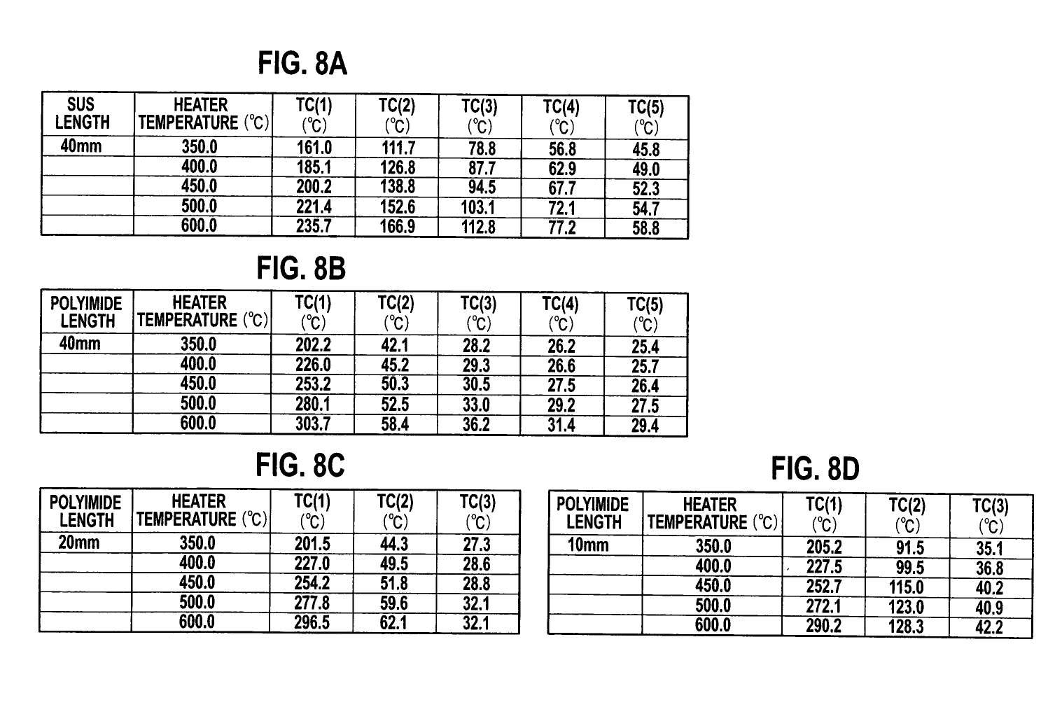

FIG. 7A to FIG. 7D and FIG. 8A to FIG. 8D show examples in which the connecting members according to the embodiment were evaluated for the thermal characteristics. FIG. 7A shows a connecting member as a comparison example that is a SUS piping of ⅛ inch. FIG. 7B shows a connecting member according to an embodiment having a length of 40 mm. FIG. 7C shows a connecting member according to an embodiment having a length of 20 mm. FIG. 7D shows a connecting member according to an embodiment having a length of 10 mm. A plurality of thermocouples (TC) were arranged in the length direction of each connecting members with an interval of 10 mm to measure the temperatures. However, TCs were placed at the center of the connecting member and both ends of a linkage section to measure the temperatures in FIG. 7D. One side of each of the connecting members shown in FIG. 7A to FIG. 7D was attached with aluminum block heaters to heat the side to a predetermined temperature to measure the temperature changes at the respective positions.

As can be seen from tables of FIG. 8A to FIG. 8B having an identical tube diameter, the connecting member according to the embodiment of the present invention can remarkably reduce the thermal conduction of the tube in the axial direction when compared with the case of a conventional SUS piping. Furthermore, as shown in FIG. 8C and FIG. 8D, the structure having a shorter length in the axial direction can still suppress the thermal conduction when compared with the comparison example of FIG. 8A and thus can contribute to a smaller size.

### (Hydrogen Generation Apparatus)

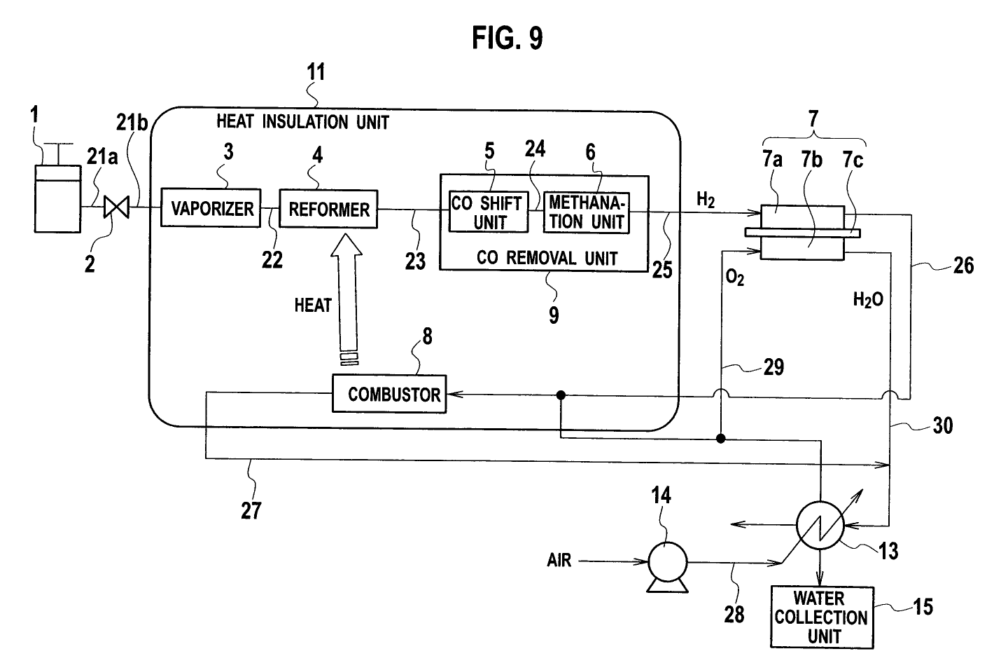

FIG. 9 shows a hydrogen generation apparatus (fuel cell system) in which the connecting member according to the embodiment is applied. The hydrogen generation apparatus according to the embodiment of the present invention includes a container 1 for storing organic raw material and water; a vaporizer 3 for vaporizing organic raw material to prepare organic matter-containing gas; a hydrogen generator (reformer) 4 for generating hydrogen-containing fluid from organic matter-containing gas; and a carbon monoxide removal unit 9 for removing carbon monoxide from hydrogen-containing fluid.

The container 1 stores therein organic raw material and water as fuel. Organic raw material may be alcohol (e.g., methanol, ethanol), fossil fuel (e.g., ethane, propane, gasoline, kerosene), ether (e.g., dimethyl ether), or liquid raw material containing hydrogen atoms. When methanol is used as organic raw material, fluid supplied to the vaporizer 3 preferably contains methanol and water with a molar ratio of 1:1 to 1:2. When liquefied gas such as dimethyl ether is used as organic raw material, the material is desirably obtained by adding methanol of a weight ratio of 5 to 10% to a mixture of dimethyl ether and water. Organic raw material and water also may not be mixed in the container 1 and also may be mixed in connecting members 21a and 21b leading to the vaporizer 3 or in the vaporizer 3 or also may be previously mixed in the container 1.

The container 1 is connected to a flow rate controller 2 via the piping 21a. The flow rate controller 2 may be, for example, a diaphragm pump, a plunger pump, a gear pump, a tube pump, an orifice, a needle valve, a bellows valve, a diaphragm valve, or a butterfly valve. The flow rate controller 2 also may be a combination of a plurality of orifices having different shapes or a temperature variable orifice by which a temperature is adjusted to change the viscosity of fluid to adjust a flow rate for example.

Liquid organic raw material passing through the flow rate controller 2 is supplied to the vaporizer 3 via the connecting member 21b. The vaporizer 3 heats at least one of organic raw material or water at 150 to 200° C. to vaporize organic raw material or water to generate organic matter-containing gas. The organic matter-containing gas generated by the vaporizer 3 is supplied to the reformer 4 via the connecting member 22 and is heated to about 350° C. The reformer 4 includes therein a flow path through which organic matter-containing gas passes. The inner wall face of the flow path 5 includes reforming catalyst for promoting a reforming reaction of organic raw material to reform the organic matter-containing gas to hydrogen-containing fluid (reforming gas).

The hydrogen-containing fluid generated by the reformer 4 is supplied to a carbon monoxide shift unit (CO shift unit) 5 via a piping 23. The CO shift unit 5 includes therein a flow path through which hydrogen-containing fluid passes. A shift catalyst for promoting the shift reaction of carbon monoxide included in hydrogen-containing fluid is provided with the inner wall face of the flow path. The CO shift unit 5 is heated to about 275° C. so that carbon monoxide included in hydrogen-containing fluid reacts with water to cause a shift reaction of carbon dioxide and hydrogen to reduce the amount of carbon monoxide in the hydrogen-containing fluid.

The hydrogen-containing fluid having reduced carbon monoxide at the CO shift unit 5 is supplied to a methanation unit 6 via the connecting member 24. The hydrogen-containing fluid supplied from the CO shift unit 5 still includes carbon monoxide of about 1%. Thus, the methanation unit 6 allows a methanation reaction to proceed at about 250° C. to allow carbon monoxide remaining in hydrogen-containing fluid to react with hydrogen to convert hydrogen-containing fluid to methane and water, thereby removing carbon monoxide. The methanation unit 6 includes therein a flow path through which hydrogen-containing fluid passes. The inner wall face of the flow path includes a methanation catalyst for promoting the methanation reaction of carbon monoxide included in hydrogen-containing fluid.

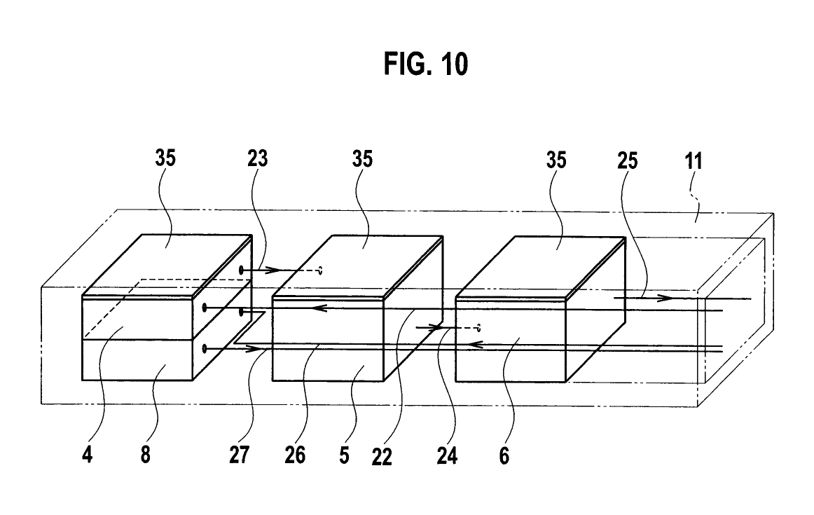

The hydrogen-containing fluid discharged from the methanation unit 6 is supplied to the power generation unit 7 via the connecting member 25. The power generation unit 7 includes a fuel electrode (anode) 7a; an air electrode (cathode) 7b; and an ion exchange type polymer electrolyte membrane (polymer electrolyte membrane: PEM) 7c sandwiched between the fuel electrode 7a and the air electrode 7b. Hydrogen in hydrogen-containing fluid reacts with oxygen in air to generate water and power generation is performed in the fuel electrode 7a. Gas including unused hydrogen discharged from the fuel electrode 7a is supplied to a combustion section 8 via the connecting member 26 and is subjected to catalytic combustion. Heat generated by the catalytic combustion is used as reforming reaction heat for fuel in the reformer 4. Heat required for reforming reaction also may be supplied from a heater 35 as shown in FIG. 10 (which will be described later). A connecting member 27 connected to the outlet side of the combustion section 8 is connected to a heat exchanger 13 and can condense water in gas discharged from the combustion section 8 to supply water to a water collection unit 15. Water in the water collection unit 15 also may be used to maintain moisture in the ion exchange type polymer electrolyte membrane 7c of the power generation unit 7.

The upstream side of the air electrode 7b is connected with the connecting member 29 to supply air to the air electrode 7b of the power generation unit 7. Air supplied from the pump 14 is supplied to the heat exchanger 13 for heating air via the connecting member 28 connected to the pump 14 and is supplied to the air electrode 7b via the connecting member 29 connected to the heat exchanger 13. The outlet side of the air electrode 7b is connected with the connecting member 30. Fluid discharged from the air electrode 7b passes through the connecting member 30 and is introduced into the heat exchanger 13 connected to the connecting member 30. Then, water in the fluid is condensed in the heat exchanger 13 and water is collected in the water collection unit 15 and the rest is discharged to outside. The ion exchange type polymer electrolyte membrane 7c may be, for example, a fluorinated ion exchange film, a polybenzoimidazol porous film (PBI), or a polyimide porous film (PI).

As shown in FIG. 9, the hydrogen generation apparatus (fuel cell system) according to the present embodiment, the connecting members shown in FIG. 1 to FIG. 3 can be used as the pipings 21a, 21b, and 22 to 30. Therefore, the length of the connecting members can be shorten compared with a case where stainless-steel connecting members are used. As a result, a space occupied by the connecting members is reduced and the entire system can be downsized. Furthermore, the connecting members shown in FIG. 1 to FIG. 3 are made of polyimide resin that can endure a high temperature of 250° C. or more. Thus, it can be preferably used for a hydrogen generation apparatus that is operated under conditions at relatively high temperature of about 100 to about 350° C.

In particular, in the hydrogen generation apparatus shown in FIG. 9, the shift reaction and methanation reaction in the CO shift unit 5 and the methanation unit 6 tend to be influenced by temperature. For example, a change in the reaction temperature of about 5 to 20° C. may cause a change in the carbon monoxide removal rate in the entire CO remover 9 to inhibit the power generation in the power generation unit 7. The use of the connecting member according to embodiment can reduce a thermal conductivity and thus the CO shift unit 5 and the methanation unit 6 can have preferred reaction temperatures and a smaller size can be realized. Furthermore, a power generation efficiency sufficient to provide power for a small power source also can be obtained. For example, when methanol of 0.011 mol/minute and water of 0.016 mol/minute as fuel are allowed to flow and the reformer 4 is operated at about 300° C. and the carbon monoxide removal unit 9 is operated at about 250° C. in FIG. 9, the outlet side of the connecting member 25 can provide hydrogen of about 0.020 mol/minute. When the resultant hydrogen is introduced into the power generation unit 7 to generate power, power of 40 W or more is obtained.

### (Assembling Image of the Hydrogen Generation Apparatus)

FIG. 10 shows an assembling image of the hydrogen generation apparatus as shown in FIG. 9. A heat insulation unit 11 is made of aluminum and the like. The heat insulation unit 11 serves as a case for providing a heating efficiency and an uniform temperature, for protecting components having a low heat resistance (e.g., surrounding electronic circuit), and for storing various reactors. The heat insulation unit 11 includes therein the combustion section 8. The combustion section 8 has thereon the reformer 4. The CO shift unit 5 is positioned to have a distance from the combustion section 8 and the reformer 4. The methanation unit 6 is positioned to have a fixed distance from the CO shift unit 5. The reformer 4, the CO shift unit 5, and the methanation unit 6 have thereon a heater 35 for heating the reformer 4, the CO shift unit 5, and the methanation unit 6.

By using the connecting member according to the embodiment in the hydrogen generation apparatus shown in FIG. 10, the pipings 22 to 24 for connecting apparatuses driving at different reaction temperatures can have a reduced length, hence leading to a constitution in a smaller size.

### ILLUSTRATIVE EXAMPLES

### First Example

An SUS316L special thin tube as the inner tube 101 in a first example (outer diameter of 1.5 mm, thickness of 0.10 mm, inner diameter of 1.3 mm, length of 20 mm, both ends of 5 mm where the tube is welded with the reactor) was surrounded by polyimide adhesive agent (KYOCERA Chemical Corporation: CT4150) as the intermediate layer 102 and was fixed. The special thin tube fixed with the polyimide adhesive agent was sandwiched by VESPEL® (made by Dupont: SP1 and length of 20 mm)) as the outer tube 103 having an outer diameter of 3.06 mm and an inner diameter of 1.8 mm. Then, the special thin tube sandwiched by VESPEL® was placed in a furnace at 300° C. to cure the polyimide adhesive agent, thereby preparing a connecting member according to the first example.

One end of the connecting member according to the first example was connected with a reactor at 300° C. and the temperature of the other end of the connecting member was measured. The result was that the temperature of the other end was 40° C. or less (about 27 to 32° C.). On the other hand, when a hitherto known SUS316L-made connecting member having identical outer diameter and inner diameter as those of a connecting member according to the first example was subjected to the same measurement, the other end showed a temperature of about 80° C. (78 to 87° C.). Thus, in the first example, a reactor at higher temperature can have an improved thermal efficiency when compared with a conventional case.

When the connecting member according to the first example was connected between a high temperature reactor having a reaction temperature of about 300° C. and a reactor having a reaction temperature of about 200° C. to operate the hydrogen generation apparatus, the connecting member having a length of about 2.5 cm allowed the operation at the respective predetermined temperatures. On the other hand, when a hitherto known SUS316L-made connecting member having identical outer diameter and inner diameter as those of the connecting member according to the first example was subjected to the same measurement, the connecting member was required to have a length of 80 mm in order to allow the reactor having a higher temperature to operate at reaction temperature of about 300° C. and the reactor having lower temperature to operate at reaction temperature of about 200° C. Thus, the hitherto known connecting member required to have a larger size than that required by the system according to the first example. Furthermore, when the connecting member according to the first example is applied for the hydrogen generation apparatus shown in FIG. 9, electric power of 40 W or more was obtained.

### Second Example

An SUS316L special thin tube as the inner tube 101 in a second example (outer diameter of 1.5 mm, thickness of 0.10 mm, inner diameter of 1.3 mm, length of 20 mm, both ends of 5 mm where the tube is welded with the reactor) was surrounded by polyimide adhesive agent (KYOCERA Chemical Corporation: CT4150) as the intermediate layer 102 and was fixed. The special thin tube fixed with the polyimide adhesive agent was sandwiched by VESPEL® (made by Dupont: SP1 and length of 20 mm)) as the outer tube 103 having an outer diameter of 3.06 mm and an inner diameter of 1.8 mm in an argon gas atmosphere. Then, the special thin tube sandwiched by VESPEL® was placed in a furnace of argon atmosphere at 300° C. to cure the polyimide adhesive agent.

One end of the connecting member according to the second example was connected with a reactor at 250° C. (CO removal unit 9 in FIG. 9) by laser welding and the other end of the connecting member was connected with a reactor at 120° C. (heat exchanger 13 in FIG. 9) by laser welding. When the hydrogen generation apparatus is operated in such a condition, the reactors were properly operated at predetermined temperatures, respectively. The length of the connecting member was about 3.0 cm. On the other hand, when a hitherto known SUS316L-made connecting member having identical outer diameter and inner diameter as those of the connecting member according to the second example was subjected to the same measurement, the connecting member was required to have a length of 100 mm. In addition, the hitherto known connecting member required a larger size than that required by the system according to the second example. Furthermore, when the connecting member according to the second example is applied for the hydrogen generation apparatus shown in FIG. 9, electric power of 40 W or more was obtained.

### Third Example

The outer tube 103 of VESPEL® (made by Dupont: outer diameter of 3.16 mm, thickness of 0.80 mm, inner diameter of 1.56 mm, and length of 20 mm) is divided to two parts in the axial direction to engage the parts to each other. Then, an SUS316L special thin tube as the inner tube 101 in a third example (outer diameter of 1.5 mm, thickness of 0.10 mm, inner diameter of 1.3 mm, length of 20 mm, both ends of 5 mm where the tube is welded with the reactor) was sandwiched by the VESPEL. Commercially available polyimide adhesive agent as the intermediate layer 102 is provided in a space between the inner tube 101 and the outer tube 103. Then, the special thin tube sandwiched by the VESPEL was placed in a furnace to cure the polyimide adhesive agent, thereby preparing a connecting member according to the third example.

One end of the connecting member according to the third example was connected with a reactor at 300° C. and the temperature of the other end of the connecting member was measured. The result was that the temperature of the other end was 40° C. or less (about 27 to 32° C.).

Furthermore, one end of the connecting member according to the third example was connected with a reformer at 300° C. and the other end of the connecting member was connected with a heat exchanger at 1000C. In such a condition, when the hydrogen that provides electric power of about 50 W is generated, the reactors were properly operated at predetermined temperatures, respectively.

### Fourth Example

Connecting members according to the first to third examples were used as the piping 23 between the reformer 4 of the hydrogen generation apparatus shown in FIG. 9 and the carbon monoxide removal unit 9. The reformer 4 and the carbon monoxide removal unit 9 had capacities of 10×10⁻⁶ m³ (10 cc), respectively, and flow paths in the reformer 4 and the carbon monoxide removal unit 9 were filled with plate-like catalysts. The reformer 4 was composed of a Cu/ZnO supporting catalyst and the carbon monoxide removal unit 9 was composed of PtReCeO₂/Al₂O₂. The reformer 4 had a reaction temperature of about 300° C. and the carbon monoxide removal unit 9 had about 250° C. The connecting member 23 had a length of about 10 mm and was connected by laser welding to the reformer 4 and the carbon monoxide removal unit 9. When the hydrogen generation apparatus of FIG. 9 was filled with methanol prepared so as to provide hydrogen that can provide power of 45 W, both of the reformer 4 and the carbon monoxide removal unit 9 could be operated with the predetermined temperatures in an efficient manner. Furthermore, hydrogen corresponding to 40 W electric power generation also could be obtained.

### Other Embodiments

Various modifications will become possible for those skilled in the art after receiving the teachings of the present disclosure without departing from the scope thereof.

In the above-described embodiments, connecting members are provided between reactors. However, applicable examples are not limited thereto. For example, housings of reactors may be made of the same materials as the connecting members of the present embodiment to decrease the heat capacity of the reactors themselves.

What is claimed is:

1. A connecting member comprising:
a metallic inner tube surrounding a flow path for fluid;
a polyimide resin-made outer tube covering the inner tube; and
a polyimide resin-made intermediate layer provided between the inner tube and the outer tube.

2. The connecting member of claim 1, wherein the intermediate layer includes at least any of a polyimide resin foam, a polyimide adhesive agent, and a polyimide film.

3. The connecting member of claim 1, wherein the intermediate layer includes a plurality of foams filled with gas having a thermal conductivity lower than air.

4. The connecting member of claim 3, wherein the gas includes inert gas.

5. A hydrogen generation apparatus comprising:
a vaporizer configured to vaporize at least one of organic raw material and water to generate organic matter-containing gas;
a hydrogen generator configured to generate hydrogen-containing fluid from the organic matter-containing gas;
a carbon monoxide removal unit configured to remove carbon monoxide from the hydrogen-containing fluid; and
a connecting member provided between at least any of the vaporizer, the hydrogen generator, and the carbon monoxide removal unit, including:
a metallic inner tube surrounding a flow path for the hydrogen-containing fluid;
a polyimide resin-made outer tube covering the inner tube; and
a polyimide resin-made intermediate layer provided between the inner tube and the outer tube.

6. The apparatus of claim 5, wherein the intermediate layer includes at least any of a polyimide resin foam, a polyimide adhesive agent, and a polyimide film.

7. The apparatus of claim 5, wherein the intermediate layer includes a plurality of foams filled with gas having a thermal conductivity lower than air.

8. The apparatus of claim 7, wherein the gas includes inert gas.

9. A hydrogen generation apparatus comprising:
a vaporizer configured to vaporize at least one of organic raw material or water to generate organic matter-containing gas;
a hydrogen generator configured to generate hydrogen-containing fluid from the organic matter-containing gas;
a carbon monoxide shift unit configured to shift carbon monoxide in the hydrogen-containing fluid to carbon dioxide and hydrogen;
a methanation unit configured convert carbon monoxide in the hydrogen-containing fluid to methane and water; and
a connection member provided between the carbon monoxide shift unit and the methanation unit, including:
a metallic inner tube surrounding a flow path for the hydrogen-containing fluid;
a polyimide resin-made outer tube covering an outer circumference of the inner tube; and
a polyimide resin-made intermediate layer provided between the inner tube and the outer tube.

10. The apparatus of claim 9, wherein the intermediate layer includes at least any of a polyimide resin foam, a polyimide adhesive agent, and a polyimide film.

11. The apparatus of claim 9, wherein the intermediate layer includes a plurality of foams filled with gas having a thermal conductivity lower than air.

12. The apparatus of claim 11, wherein the gas includes inert gas.

13. A fuel cell system comprising:
a container containing organic raw material and water;
a vaporizer configured to vaporize at least one of the organic raw material or the water to generate organic matter-containing gas;
a reformer configured to reform the organic matter-containing gas to hydrogen-containing fluid;
a carbon monoxide removal unit configured to remove carbon monoxide from the hydrogen-containing fluid;
a power generation unit configured to generate electric power through a reaction of oxygen with the hydrogen-containing gas from which the carbon monoxide is removed;
a combustor configured to combust an exhausted gas exhausted from the power generation unit; and
a connecting member provided between at least any of the vaporizer, the reformer, the carbon monoxide removal unit, the power generation unit, and the combustor, including:
a metallic inner tube surrounding a flow path for the hydrogen-containing fluid;
a polyimide resin-made outer tube covering the inner tube; and
a polyimide resin-made intermediate layer provided between the inner tube and the outer tube.

14. The system of claim 13, wherein the intermediate layer includes at least any of a polyimide resin foam, a polyimide adhesive agent, and a polyimide film.

15. The system of claim 13, wherein the intermediate layer includes a plurality of foams filled with gas having a thermal conductivity lower than air.

16. The system of claim 13, wherein the gas includes inert gas.

17. The system of claim 13, wherein the organic raw material includes alcohol, fossil fuel, ether, and liquid raw material containing hydrogen.

18. The system of claim 13, wherein the organic raw material includes methanol and dimethyl ether.

19. The system of claim 13, wherein the vaporizer, the reformer, and the carbon monoxide removal unit are heated to about 100-350° C.
